(19) United States
(12) Patent Application Publication
(10) Pub. No.: US 2012/0144438 A1
(43) Pub. Date: Jun. 7, 2012

(54) METHOD AND APPARATUS FOR DISTRIBUTING CONTENT VIA A NETWORK TO USER TERMINALS

(75) Inventor: Zulfiquar Sayeed, Hightstown, NJ (US)

(73) Assignee: Alcatel-Lucent USA Inc. via the Electronic Patent Assignment System (EPAS)

(21) Appl. No.: 12/958,644

(22) Filed: Dec. 2, 2010

(51) Int. Cl. H04N 7/173

(52) U.S. Cl. 725/93; 725/116

(57) ABSTRACT

A method and apparatus for distributing content via a network to user terminals includes storing content in a store, the content having a probability value indicating the probability that the content will be required by the user terminals. The content is separated into segments, each segment being associated with a respective segment probability value derived at least from the probability value of the content. The segments are ranked using at least the respective segment probability values. During a time period when the network capacity is greater than at another time, the top J ranked segments, where J is related to the broadcasting bit rate and duration of the broadcast, are predictively broadcast to user terminals.

### FIELD OF THE INVENTION

The present invention relates to a method and apparatus for distributing content via a network to user terminals.

### BACKGROUND

Various types of content, notably video and audio content, may be delivered in a number of ways to consumers. For example, video content may be broadcast via a wireless cellular network to a number of users simultaneously. However, this approach incurs significant network resources and may lead to congestion and reduced performance, resulting in user dissatisfaction.

### BRIEF SUMMARY

According to a first aspect of the invention, a method for distributing content via a network to user terminals includes storing content in a store, the content having a probability value indicating the probability that the content will be required by the user terminals. The content is separated into segments, each segment being associated with a respective segment probability value derived at least from the probability value of the content. The segments are ranked using at least the respective segment probability values. During a time period when the network capacity is greater than at another time, the top J ranked segments, where J is related to the broadcasting bit rate and duration of the broadcast, are predictively broadcast to user terminals.

Predictive broadcasting is broadcasting content before a request is received for the content from user terminals.

Users increasingly want to view or listen to content at times convenient for them instead of relying on scheduled broadcasts by content providers, and this increases demands placed on networks by the need to provide unicast deliveries to users. By using a method in accordance with the invention involving predictive broadcasting, unicast loading in a network may potentially be reduced. By predicting what content is likely to be wanted by users and broadcasting content in advance of a request for the content to be delivered, network congestion at peak times may be reduced, taking advantage of the greater capacity available at other times to distribute content. In one embodiment, segments are predictively broadcast at given times when network loads tend to be lower, for example, overnight. In an embodiment, network loading is monitored and segments are predictively broadcast at times when the monitored network load is lower than a threshold level. These may be alternative approaches or used in combination, for example.

Following predictive broadcast of those segments deemed most likely to be wanted, a user may then access the content previously broadcast whenever it is convenient to the user. If not all of the segments making up a particular piece of content have been stored at the user terminal, or locally thereto, because all segments were not predictively broadcast, then the remaining segments may be requested by the user, for example, by a request for unicast transmission of the missing segments to the user terminal.

In one method according to the invention, the segments are ranked based on at least the product of their probability value and the broadcasting bit rate. In a method in accordance with the invention, segments are ranked using additional parameters, such as, for example, arranging for segments to be ranked based on marketing requirements of a content provider. Other parameters may be used instead or in addition to allow refinement of the ranking procedure.

The probability value of content may be calculated using a suitable algorithm. For example, the Netflix Prize was a competition which drew many entries aimed at providing a filtering algorithms that could be used to predict users responses to content. It would be within the skill of one practised in the field to produce an algorithm suitable for a particular application of the invention.

In one method in accordance with the invention, a higher probability value is allocated to segments from the beginning of the content than to segments nearer the end of the content.

In a method in accordance with the invention, J is derived from an inequality that is a function of the broadcasting bit rate and the time allocated for the broadcast duration. In one embodiment, to reduce the numbers of segments broadcast, the top J ranked segments may exclude segments previously predictively broadcast and that are cached at the user terminals, for example.

The predictively broadcast segments may be held in a cache included in the user terminal or local thereto for ready access, for example. In an embodiment of the invention, the segments include retention information to indicate when segments are to be shed from caches at the user terminals. Predictively broadcast segments may include information relating to genre of the segments to enable a user terminal to identify which of the predictively broadcast segments are to be stored at its associated cache. Those of a genre more likely to be of interest to a user are cached in preference to those not indicated as being of interest, or for example, a favored genre may be held in a cache for longer.

In a method in accordance with the invention, the probability value of content is modified based on the demand for the content by user terminals. For example, content proving to be more popular may be given a higher probability value.

A method in accordance with the invention may be used, for example, with a network in accordance with the 3GPP Long Term Evolution (LTE) standard and segments are predictively broadcast using Multimedia Broadcast Multicast Service (MBMS). MBMS is available using current networks based on GSM and UMTS technology for delivering mobile TV. With MBMS, an uplink channel is provided for interaction between the service and the user.

According to a second aspect of the invention, apparatus for distributing content via a network to user terminals, includes: a store for storing content; a probability density function calculator for calculating a probability value of the content, the probability value indicating the probability that the content will be required by the user terminals; a segmenter for separating the content into segments, each segment being associated with a respective segment probability value derived at least from the probability value of the content; a processor for ranking the segments using at least the respective segment probability values; and a transmitter operative to predictively broadcast to user terminals the top J ranked segments, where J is related to the broadcasting bit rate and duration of the broadcast, during a time period when the network capacity is greater than at another time.

### BRIEF DESCRIPTION OF THE DRAWING

Some embodiments of the present invention will now be described by way of example only, and with reference to the accompanying drawings, in which:

FIG. 1 schematically illustrates an arrangement involving a method in accordance with the invention.

### DETAILED DESCRIPTION

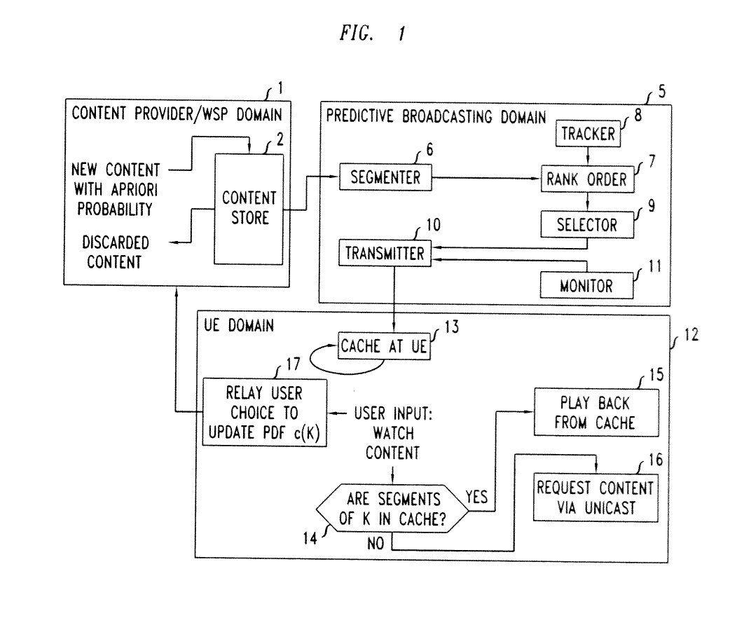

With reference to FIG. 1, in a content provider/web site publisher (WSP) domain 1, a content store 2 is supplied with new content, which may for example, be video or audio content, via input 3. It is intended that the stored content be made available to users over a network, in this case, a cellular wireless network implemented in accordance with 3GPP LTE standards and where certain content is to be predictively broadcast using MBMS services. Each piece of content that is added to the store 2 is associated with an a priori probability that it is likely to be wanted by users. The a priori probability may be chosen based a probability density function (pdf) related to previous demands for similar content, say, or using some other basis. When content is no longer needed for transmission to users, it is discarded at 4 from the store 2.

The content store 2 holds content {c(i)} with probability values {p(i)}, bit-rate {b(i)} and duration {d(i)}, where i=1 . . . N and N may possibly be ∞. Newly added and discarded content affects the pdf {p(i)}. In this embodiment, the user behavior is used to modify the pdf of the stored content over time and the user behavior can also be predicted so as to give an assessment of what content should be predictively broadcast.

Content {c(i)} from the content store 2 is transferred to a predictive broadcasting domain 5 where it is divided into segments by a segmenter 6. Each content c(i) is broken into τ minute duration segments. This gives:

{c′(j)}; j=1 . . . M(i)*N; i=1 . . . N, where M(i) is the maximum number of segments in c(i).

Each segment has an associated probability of being requested by a user derived from {p(i)}. This gives: c′(j), {p′(j), b′(j)} where all c′(j) are τ minutes long. The segments may have respective different broadcast bit-rates and use different encoders. Where different encoders are used, the encoding format associated with a segment or segments is relayed to user equipment in Session Description Protocol updates.

The segments c′(j) are applied to a ranking processor 7 which ranks the order of the segments by the product of the respective segment probability values and the broadcast bit rate to give a ranked list {c″(j), b″(j), p″(j)}. When carrying out the ranking function, the processor 7 accesses information from a tracker 8 which tracks what segments have been previously broadcast and which are not yet sufficiently aged to have been discarded from caches at the user terminals. More popular content may have a longer retention time at user caches. The ranking processor 7 uses the information from the tracker 8 to exclude segments from the ranked list that are still available locally to user terminals.

A selector 9 access the ranking processor 7 and selects the top J segments from the ranked list, where J is given by the inequality:

Sum(j=1 . . . J)(b″(j)*60*τ)≦BW_{—}BC*BW_duration_sec

where BW_BC is the bandwidth dedicated for broadcast during network idle time; and BW_duration_sec is the seconds required to use the MBMS service to predictively broadcast the J segments during network idle time.

The selected J segments are sent to a transmitter 10 to be predictively broadcast to user terminals during network idle time. The predictive broadcasts may be carried out during set periods when it is assumed that network loads tend to be low, for example, overnight or in the early morning, or alternatively a network monitor 11 may be used to detect when the network has spare capacity, or other mechanisms could be used, for example, a combination of these two approaches could be used.

The predictively broadcast segments are received at user terminals (UEs). One user terminal domain is illustrated at 12. The received broadcast is cached at a cache 13 in the UE. In one embodiment, the user is able to select a genre or genres that is of interest to them. This preference may be part of the network provisioning or directly related to predictive broadcasting. Where genre selection is available, the UE decides which of the J segments that it has received are to be stored at cache 14 based on that user's preferences. This filtering may reduce the required cache size. Additionally, information concerning retention of a segment is used to discard aged content from the cache 13.

The user decides to watch a particular content K; Kε(i:1 to N). The local cache 13 is checked at 14 to determine if the segment(s) referenced by the content desired are present. If the required segments are available, then the content is consumed from cache 13 as shown at 15. However, if additional segments are required to build the content to be watched, the additional content is requested as a unicast request, shown at 15, from the UE 12 to the content provider domain 1.

Irrespective of whether the content is retrieved from the cache 13 or via unicast following a request from the user, the user demand for that content is transmitted back at 17 to the content provider for updating the pdf of content that is held in the content store 2.

The functions of the various elements shown in the FIGURE, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGURE are conceptual only. Their function may be carried out through the operation of program logic, through dedicated logic, through the interaction of program control and dedicated logic, or even manually, the particular technique being selectable by the implementer as more specifically understood from the context.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A method for distributing content via a network to user terminals, including:
storing content in a store, the content having a probability value indicating the probability that the content will be required by the user terminals;
separating the content into segments, each segment being associated with a respective segment probability value derived at least from the probability value of the content;
ranking the segments using at least the respective segment probability values; and
during a time period when the network capacity is greater than at another time, predictively broadcasting to user terminals the top J ranked segments, where J is related to the broadcasting bit rate and duration of the broadcast.

2. The method as claimed in claim 1 including ranking the segments using at least the product of their probability value and the broadcasting bit rate.

3. The method as claimed in claim 1 and, when requested by a user terminal, unicasting to said user terminal segments not predictively broadcast.

4. The method as claimed in claim 1 and allocating a higher probability value to segments from the beginning of the content than to segments nearer the end of the content.

5. The method as claimed in claim 1 wherein J is derived from an inequality that is a function of the broadcasting bit rate and the time allocated for the broadcast duration.

6. The method as claimed in claim 1 wherein the top J ranked segments excludes segments previously predictively broadcast and that are cached at the user terminals.

7. The method as claimed in claim 1 wherein the segments include retention information to indicate when segments are to be shed from caches at the user terminals.

8. The method as claimed in claim 7 wherein the caches are included in the user terminals.

9. The method as claimed in claim 1 wherein segments are ranked including a parameter based on marketing requirements of a content provider.

10. The method as claimed in claim 1 wherein predictively broadcast segments include information relating to genre to enable a user terminal to identify which of the predictively broadcast segments are to be stored at its associated cache.

11. The method as claimed in claim 1 wherein segments are predictively broadcast at given times when network loads tend to be lower.

12. The method as claimed in claim 1 including monitoring network loading and predictively broadcasting segments at times when the monitored network load is lower than a threshold level.

13. The method as claimed in claim 1 including modifying the probability value of content based on the demand for the content by user terminals.

14. The method as claimed in claim 1 wherein the network is in accordance with the 3GPP Long Term Evolution (LTE) standard and segments are predictively broadcast using Multimedia Broadcast Multicast Service (MBMS).

15. An apparatus for distributing content via a network to user terminals, including: a store for storing content; a probability density function calculator for calculating a probability value of the content, the probability value indicating the probability that the content will be required by the user terminals; a segmenter for separating the content into segments, each segment being associated with a respective segment probability value derived at least from the probability value of the content; a processor for ranking the segments using at least the respective segment probability values; and a transmitter operative to predictively broadcast to user terminals the top J ranked segments, where J is related to the broadcasting bit rate and duration of the broadcast, during a time period when the network capacity is greater than at another time.

16. The apparatus as claimed in claim 15 including ranking the segments using at least the product of their probability value and the broadcasting bit rate.

17. The apparatus as claimed in claim 15 including a receiver for receiving a request from a user terminal and the transmitter operative to unicast to user terminal segments not predictively broadcast.

18. The apparatus as claimed in claim 15 wherein J is derived from an inequality that is a function of the broadcasting bit rate and the time allocated for the broadcast duration.

19. The apparatus as claimed in claim 15 wherein the top J ranked segments excludes segments previously predictively broadcast and that are cached at the user terminals.

20. The apparatus as claimed in claim 15 wherein the transmitter is arranged to predictively broadcast segments at given times when network loads tend to be lower.

21. The apparatus as claimed in claim 15 including a monitor to monitor network loading and wherein the transmitter is arranged to predictively broadcast segments when the monitored network load is lower than a threshold level.

22. The apparatus as claimed in claim 15 and the calculator being adapted to modify the probability value of content based on the demand for the content by user terminals.

23. The apparatus as claimed in claim 15 wherein the network is in accordance with the 3GPP Long Term Evolution (LTE) standard and segments are predictively broadcast using Multimedia Broadcast Multicast Service (MBMS).
